(19) United States
(12) Patent Application Publication
(10) Pub. No.: US 2026/0267326 A1
(43) Pub. Date: Sep. 10, 2026

(54) SYSTEM AND METHOD FOR ANALYSING A SYSTEM OF ASSETS

(71) Applicant: IMRANDD Ltd, Banchory (GB)

(72) Inventor: Callum RAMSEY, Aberdeen (GB)

(21) Appl. No.: 19/167,568

(22) PCT Filed: Mar. 20, 2024
(86) PCT No.: PCT/GB2024/050751

§ 371 Date: Sep. 22, 2025

(30) Foreign Application Priority Data
Mar. 20, 2023 (GB) 2303990.2

(51) Int. Cl. G05B 23/02

(52) U.S. Cl. CPC G05B 23/0283

(57) ABSTRACT

An asset monitoring system (5) for monitoring a system of physical assets, the monitoring system (5) being configured to: collect data (210) relating to at least part of the system of assets; implement one or more deterioration models (340), each of the one of the one or more deterioration models (340) being configured to model deterioration of at least one asset of the system of assets; implement a set or pre-set barrier model (345), the barrier model (345) modelling a resistance to the deterioration of the at least one asset; apply the data to the one or more deterioration models (340) and the one or more barrier models (345) in order to determine a condition or degradation related parameter (225) of the at least one asset; and take an action based on the determined condition or degradation related parameter (225) of the at least one asset.

### TECHNICAL FIELD

Described herein is an analysis system for analysing or monitoring a system of assets such as, but not limited to, items of plant such as pipes, valves, tanks and/or the like. The analysis system can analyse and/or monitor asset data to determine change in condition of the asset equipment and thereby take action, such as raising a flag or alarm, providing a visualisation or status or the like, based on the determined change in condition of the asset equipment.

### BACKGROUND

Poor confidence in the quality of inspection and other plant data is widely accepted as a persistent problem affecting the entire oil & gas industry, as inspector or measurement error can be minimised but not eliminated. As a result, preventable failures are often missed, data trending can remain the goal but not the reality, failure patterns and hotspots are not identified, and genuine anomalies are often overlooked.

As such, there is a need for a rapid and cost-effective methodology to restore confidence in inspection and measurement data, enabling evaluation of threat levels associated with an asset and for improving asset or degradation management.

In particular, improved asset management, including but not limited to repair, operation and replacement of assets, would be beneficial. In the context of this disclosure, assets are physical assets, such as physical items, equipment or apparatus or components thereof. Systems of assets are physical systems comprising a plurality of assets in the form of physical items arranged or connected together in order to perform a function.

This background serves only to set a scene to allow a skilled reader to better appreciate the following description. Therefore, none of the above discussion should necessarily be taken as an acknowledgement that the discussion is part of the state of the art or is common general knowledge. One or more aspects/embodiments of the invention may or may not address one or more of the background issues.

### SUMMARY

Various aspects of the present invention are defined in the independent claims. Some preferred features are defined in the dependent claims.

According to a first example of the present disclosure is an asset monitoring system for monitoring a system of physical assets, the monitoring system being configured to:
collect data relating to at least part of the system of assets;
implement one or more deterioration models, each of the one of the one or more deterioration models being configured to model deterioration of at least one asset of the system of assets;
apply the data to the one or more deterioration models in order to determine a condition or degradation related parameter of the at least one asset; and
take an action based on the determined condition or degradation related parameter of the at least one asset.

The asset monitoring system may be configured to implement set or pre-set barrier models, the barrier models modelling a resistance to the deterioration of the at least one asset. The set or pre-set barrier models could comprise one or more barrier models or may comprise no barrier model, e.g. for asset/deterioration mechanism combinations for which no barrier mechanism is present. The asset monitoring system may be configured to apply the data to the one or more deterioration models and to the set or pre-set barrier models, which may comprise zero or one or more barrier models, in order to determine a condition or degradation related parameter of the at least one asset. The set or pre-set barrier model may be manually set or pre-set, e.g. via a user input, or automatically via a rule, database check, algorithm, mapping, look-up-table, metadata, and/or the like.

The system of assets may be, comprise or be comprised in a flow system configured for at least one of: constrained flow or other transport, storage and/or processing of at least one fluid, such as a gas and/or liquid, flows. The system of assets may be, comprise or be comprised in a plant, processing facility, factory, production facility, hydrocarbon extraction, processing or handling facility, and/or the like. The assets of the system of assets may be or comprise at least one of: pipes or pipework, conduits, pumps, valves, meters, tanks, storage chambers, injectors, extruders, pistons, actuators, flow channels or flow guides, and/or the like. Such flow systems are commonly used in the oil and gas industry, both upstream and downstream, in chemical processing, in factories and other production or processing facilities, water treatment, energy generation and storage, food handling and processing, agricultural processes, and other from among a number of other possibilities. However, the present disclosure is not limited to these examples, and can in principle be applied to any suitable situation that comprises a system of assets where the assets are subject to some form of deterioration, and assessment of that deterioration in order to perform some form of action depending on the deterioration is required. It will be appreciated that, as used herein, the assets are physical assets, such as physical items, equipment or apparatus or components thereof. The system of assets is a physical system comprising a plurality of assets in the form of physical items arranged or connected together in order to perform a function.

The one or more deterioration models may be or comprise damage mechanism models. The one or more deterioration models may be configured to determine a deterioration rate, such as a corrosion rate of the at least one asset. The one or more deterioration models may be configured to determine a probability of failure of the at least one asset. Each of the one or more deterioration models may model a different degradation mechanism, e.g. different forms of chemical and/or physical degradation mechanisms, such as one or more of: rusting, oxidation, chemical degradation, abrasion, erosion, pitting, and/or the like. The one or more deterioration model may be configured to output an unmitigated deterioration rate of the at least one asset. The one or more deterioration model may be configured to output the unmitigated deterioration rate of the at least one asset as at least one input to the at least one barrier model.

Each of the one or more barrier models may model at least one resistance mechanism that resists degradation of the at least one asset. The at least one resistance mechanism may comprise one or more of: a coating or other barrier layer, sleeve, protecting additive or other chemical, dehydration level, electrical insulation, and/or the like. The monitoring system may be configured to apply the one or more barrier models to the output of the one or more deterioration models, e.g. to modify the outputs of the one or more deterioration models. The one or more barrier models may be configured to output mitigated versions of the condition, parameter and/or property of the at least one equipment asset. The one or more barrier models may be configured to receive as an input and act on one or both of: the unmitigated deterioration rate of the at least one asset from the at least one deterioration model; and/or at least some of the data, such as data relating to the at least one equipment asset modelled by the at least one barrier model.

At least one or some or all of the one or more barrier models may be specific to an associated deterioration mechanism. At least one or some or all of the one or more barrier models may be applied to modify the output of a corresponding one or more deterioration models that model for the associated deterioration mechanism. The one or more barrier models may be applied as a modification to the one or more deterioration models, or to at least some of the data provided thereto, wherein the modification may at least partly account for the effect of the at least one resistance mechanism. The one or more barrier models may be adversarial or otherwise act in opposition to the one or more deterioration models.

The determined condition or degradation related parameter of the at least one asset may be or comprise at least one or both of: a current and/or future parameter of the at least one asset. The parameter of the at least one asset may be or comprise a condition or an amount of degradation of the at least one asset.

The monitoring system may comprise a predictive model. The predictive model may be a machine learning model, e.g. comprising a neural network. The predictive model may comprise a data fitting method such as a line or curve fitting method. The predictive model may be arranged to receive at least one of: the output of the at least one barrier model and/or the output of the at least one deterioration model, and may be arranged to determine the condition or degradation related parameter of the at least one asset based thereon. For example, the predictive model may be configured to determine at least one or each of: remaining life, date of failure, estimated wall thickness and/or the like at a specific date and time, which may be at one or more of: a time in the future or past or in the present.

The data may be data relating to at least one asset of the system of assets. The data may be real world data, e.g. data comprising a value or a property or parameter of a physical item (such as at least one of the one or more assets).

The data may comprise real time data or near real time data relating to the at least one asset. The data may comprise manually collected and/or provided data relating to the at least one asset. The data may comprise historical and/or recent data. The data may comprise sensor data relating to the at least one asset, e.g. from a sensor collecting measurements of the at least one asset or measurements of parameters that have an effect on the at least one asset. The data may comprise physical measurements. The data may comprise inspection data relating to the at least one asset. The data may comprise operational data relating to operation of the at least one asset and/or the system of assets. The data may comprise physical data of the at least one asset, e.g. quantifying one or more physical properties of the at least one asset such as wall thickness, material, and/or the like. The data may comprise chemical data of chemicals to which the equipment asset has been exposed. The chemical data may comprise, for example, one or more of: chemical of other fluid composition, temperature, pH, reactivity and/or the like. The data may be or comprise initial physical properties of the asset, e.g. comprising initial wall thickness of the asset, such as pipe or tank wall thickness.

The monitoring system may be configured to extrapolate the data, e.g. if insufficient data is available for a given timeframe. The monitoring system may be configured to extrapolate calculated data as output by deterioration models, barrier model and/or predictive model.

The data may be tied to a date and/or time of collection, e.g. the data may be date and/or time stamped. The data may be tied to a location, such as a test point or other asset, in the system of assets at which the data was collected or to which the data refers or is otherwise relevant. At least some of the data may be received from a controller or plant information system, e.g. the data may comprise PI data. Datasets of the data may be collected over time, e.g. automatically collected and/or ingested, e.g. from sensors, measurement devices, databases of data, from manual input, and/or the like. The monitoring system may be configured to automatically seek out datasets of the data, e.g. by searching over a network, querying a controller of the system of assets, searching databases e.g. of sensor or measurement data, or inspection reports or other data, and/or the like.

The data may comprise or be comprised in one or more data sets, wherein each data set may be one or more of: from different sources; for a different time or time range; different types of data; data collected in different ways; data for different assets or types of asset; and/or the like. The monitoring system may be configured to determine or otherwise obtain confidence values for the data. The confidence values may be indicative of a confidence that the associated data is accurate. The monitoring system may be configured to determine or otherwise obtain confidence values for the condition or degradation related parameter of the at least one asset determined from the one or more deterioration models and the one or more barrier models. The monitoring system may be configured to exclude, ignore or flag for checking or recollecting the data and/or the determined condition or degradation related parameter of the at least one asset depending on its confidence value.

The monitoring system may be configured to exclude, ignore or flag for checking or recollecting the data and/or the determined condition or degradation related parameter of the at least one asset if its confidence value is below an associated threshold.

For example, the monitoring system may exclude or ignore any data and/or determined condition or degradation related parameter of the at least one asset that has a confidence value below a first threshold. The monitoring system may flag for checking or recollecting any data and/or determined condition or degradation related parameter of the at least one asset that has a confidence value at or above the first threshold but below a second threshold that is higher than the first threshold. The monitoring system may be configured to process or proceed with any data and/or determined condition or degradation related parameter of the at least one asset that is at or above the second threshold.

The monitoring system may be configured to exclude, ignore or flag for checking or recollecting the data and/or the determined condition or degradation related parameter of the at least one asset depending on a variation of values within a dataset, e.g. intra-dataset variation in values. For example, datasets having an intra-dataset variation in values above a certain level may be disregarded, excluded or at least flagged for cleansing or other further processing. The monitoring system may be configured to exclude, ignore or flag for checking or recollecting the data and/or the determined condition or degradation related parameter of the at least one asset depending on a variation of values between different datasets, e.g. inter-dataset variation in values. For example, datasets having a variation in values relative to one or more other datasets above a certain level may be disregarded, excluded or at least flagged for cleansing or other further processing, i.e. by having a low confidence value.

The confidence values may be specific to a specific asset, device, type of asset, area, zone, section or group of assets, e.g. of devices, plant, equipment and/or the like. The confidence values may be specific to a dataset or to a type of data. The confidence values may be associated with the model used.

The confidence values may be dependent on the values of the data input to the model. The confidence values may be indicative of ranges of values over which the inputs, e.g. the data, to the model has been tested, or may be expected to provide good results (e.g. theoretically or experimentally or from experience). The confidence values may be reflective of the effectiveness of the model, which may be pre-determined or pre-assigned, e.g. based on one or more of: known issues with the model; a level of testing and/or validation of the model; a complexity of the process that the model is modelling; and/or the like. For example, the confidence values may be based on one or more confidence limits, which could comprise a confidence band, or an upper confidence limit and/or a lower confidence limit and optionally one or more intermediate confidence bands, where a confidence can be reduced when the inputs, or a certain proportion of the inputs, such as the data, to the model fall out with the confidence band, above the upper confidence limit or below the lower confidence limit. Different confidence values may be applied for inputs falling on different sides of the one or more intermediate thresholds.

The monitoring system may be configured to determine justification and/or generate justification statements, for at least one or each generated confidence value. The justification statement may comprise a textual statement, a flag, indicator or the like. For example, the justification statement may indicate a confidence threshold or limit that has been exceeded or not exceeded and/or a degree to which it has been exceeded or not exceeded, that a confidence criterion has been met or not met or a degree to which it has or has not been met, an indication that intra-data set or inter-data set variation has been exceeded, and/or the like.

The confidence values may comprise a numerical or other quantitative value and optionally may be accompanied by accompanying data which may provide context or explanation, e.g. a flag, a textual justification for the confidence value, and/or the like.

As such, unlike monitoring systems that may assign definitive labels, e.g. “good data”, “bad data”, “excluded data”, “extreme data” and/or the like, using confidence values may allow more nuance and therefore accuracy in any analysis. Furthermore, the use of confidence values may make it easier to interchange models, leading to a more adaptable and updatable monitoring system. In this way, decisions whether or how to use the data may be taken, e.g. by the monitoring system, based on the confidence values rather than in absolute terms.

The monitoring system may be configured to model the system of assets. Each model may model the one or more assets, e.g. a plurality of the assets. Each asset, or part of asset or group of assets may be assigned initial data, which may be stored as metadata, such as asset type, a starting wall thickness of the asset, and/or the like. The initial data may be manually input or received from a database or collected using sensors and/or the like.

The monitoring system may be configured to group assets (e.g. devices, plant, equipment functional items, pipes or pipework, and/or the like) in a model or data structure of the system of assets. The monitoring system may be configured to group assets in a hierarchical structure or alternatively in a non-hierarchical structure. For example, the monitoring system may be configured to include one or more assets in each level of a hierarchical structure. For example, one or more of the layers of the hierarchical structure may comprise individual assets or small groups of a few localised assets. One or more higher layers of the hierarchical structure may comprise groups or larger groups of assets, such as groups comprising two or more groups of a lower layer. The one or more higher layers of the hierarchical structure may be comprise assets grouped by, as non-limiting examples, one or more of: a common location or area, a common function, being components of a common larger system or process, as part of a common corrosion circuit or line, a common circuit, common asset types, exposure to a common environment, and/or the like.

In one example, a layer such as a lowest layer of the hierarchical structure may comprise test points, and at least one other layer of the hierarchical structure may comprise lines that each comprise at least one and preferably a plurality of test points, and at least one higher layer may comprise one or more corrosion circuits that may each comprise at least one and preferably more than one line. At least one highest layer of the hierarchical structure may comprise the monitoring system of assets as a whole.

A higher level in the hierarchy may comprise more assets than a lower level that is lower in the hierarchy than the higher level. A higher level in the hierarchy may comprises the assets from a plurality of lower levels that are lower in the hierarchy than the higher level. The grouping of assets may be by location in the asset system, e.g. assets can be associated with specific locations, areas or parts of the asset system.

The one or more condition or degradation related parameter or data, such as e.g. confidence values, equipment asset data, one or more datasets, one or more variables, measurement or sensor data, and/or the like, may be associated with, e.g. automatically associated with, one or more locations, assets or parts of the system. The one or more condition or degradation related parameter or data associated with the one or more locations, assets or parts of the system may be used in at least one or each of: the one or more deterioration models, the one or more barrier models and/or the one or more predictive models for that location, asset or part of the system.

In an example, one or more condition or degradation related parameter or data for a type of asset, e.g. for a specific model or class of asset, may be propagated or assigned to or otherwise associated with each asset of that type and/or assigned to or otherwise associated with each part of the system containing that type of asset. In another example, one or more condition or degradation related parameter or data (e.g. measurements or sensor data) for a specific location may be propagated, assigned to or otherwise associated with assets or parts of the system to which that one or more condition or degradation related parameter or data applies, which may or may not be at the location the parameter or data was collected. For example, a temperature measurement made at a given location in a pipeline may be valid and applied over a certain distance downstream of that measurement point in the pipeline, and to all valves and other devices in that section of the pipeline.

The one or more condition or degradation related parameter or data may be propagated for all assets or parts of the system associated with that one or more condition or degradation related parameter or data. The other parts of the system to which to propagate or otherwise associated the one or more condition or degradation related parameter or data may be set, pre-set, or identified using logic, a mapping, rules, and/or the like. The relationship between the one or more condition or degradation related parameter or data and the at least one location, asset or part of the system may be one of: a many to one, many to many or one to many mapping. For example, many measurements and/or measurement locations may feed into a model for a single location, asset or part of the system, or many measurements or measurement locations may feed into the models for many locations, assets or parts of the system or a single measurement at a single location may be fed into the models for many locations, assets or parts of the system.

In another example, the one or more condition or degradation related parameter or data, such as e.g. confidence values, equipment asset data, one or more datasets, one or more variables, and/or the like, may be propagated, e.g. automatically propagated, between layers of the hierarchical structure, e.g. from the lower levels in the hierarchy to one or more or each higher levels. For example, the one or more condition or degradation related parameter or data may be propagated from one or more lower levels to one or more or each higher levels that comprise one or more or every asset of the one or more lower levels. For example, the one or more condition or degradation related parameter or data, such as e.g. confidence values, equipment asset data, one or more datasets and/or the like, from a lower level may be aggregated, cumulated, or otherwise combined, which may be done automatically, into the one or more higher levels in the hierarchy. In this way, reconfiguration of the models may be made easier. The aggregation of data may be into datasets relating to a defined or predefined or otherwise specified time period and/or for a specified location or part of the system of assets.

The action may comprise providing a visualization of the determined condition or degradation related parameter, which may be a future and/or present condition or degradation related parameter.

The visualization may comprise a diagram of part and/or all of the asset system, or a circuit, such as a corrosion circuit, of the asset system or one or more asset equipment of the asset system. The action taken based on the determined current and/or future condition may comprise raising an alarm, alert or other notification, which may comprise providing an indication on the visualization, an electronic message, an indication on a display, an indication in an electronic report, and audible alert, and/or the like. The action may be taken responsive to the determined condition or degradation related parameter of the at least one equipment asset, e.g. responsive to a value of at least one condition or degradation related parameter meeting an action condition, which may be an alarm, alert or flagging condition, or the like.

The visualization may comprise a data visualisation or advanced insights, e.g. which may comprise a heat map, presenting the data and/or any alarms, alerts or notifications on a plot, providing tables indicating the determined condition or degradation related parameter, e.g. a feature level or localised and/or circuit level or general degradation rates and/or areas for further investigation, a summary, representing the data and/or any alarms, alerts or notifications and/or the like on a circuit or asset diagram, e.g. a piping and instrumentation diagram (P&ID), isometric or other model, and/or the like. Different sections of data, all data or any combination thereof may be provided on different visualizations or toggled between the data types on a single visualization. The different sections of data may comprise sections of different data types, different data sets, data relating to different parts of the asset system, different properties, different degradation rates and/or the like.

The monitoring system may be configured to use identifiers, one or more properties or type classifications for each asset or line or circuit or component or portion thereof, e.g. from a data store. The monitoring system may be configured to obtain the P&ID diagram, isometric or other model diagram of at least part of the asset, line or circuit, and/or the like from the data store. The method may comprise providing indications of the equipment asset data and/or the determined condition or degradation related parameter of the at least one asset and/or the alarm, alert or flag, on the P&ID diagram, isometric or other model of the asset system, which may be provided at, or at a location dependent on, the location of or on the asset to which the data relates.

The determined condition or degradation related parameter of the at least one asset, may comprise a determined current and/or future condition of at least part of a group of assets, such as at least part of a group of assets in one or more of: at a location, in a level of the hierarchical arrangement, in a section of the asset system, in a common corrosion circuit or other circuit of the asset system, a group of assets of the same type of asset, a group of assets exposed to a common environment or environmental condition, a group of assets involved in a common process, and/or the like. The determined condition or degradation related parameter of the at least one asset may comprise at least one of: a corrosion or other degradation level, a corrosion or other degradation rate, an expected remaining lifetime, a wall thickness, reduction in wall thickness, probability of failure, and/or the like. The determined current and/or future condition of the at least one equipment asset may comprise a degradable physical property of the asset, such as a wall thickness, e.g. a pipe or tank wall thickness and/or a rate of change or degradation and/or amount of loss or reduction thereof.

The monitoring system may comprise and/or be configured to implement a user interface, which may comprise a visual user interface. The user interface may be an interactive user interface, e.g. it may be configured to accept input and/or to provide output. The user interface may be configured to provide the visualization. The user interface may be configured to provide one or more alarms, alerts or flags. The user interface may be configured to accept user input or editing of equipment asset data. The user interface may be configured to accept user control of the operation of the system, e.g. to change the visualization to display a different part of the system or hierarchy. The user interface may be configured to allow selection or switching of at least one of the deterioration models and/or at least one of the barrier models. The system may be configured to automatically and/or dynamically update at least some or all other properties, values or parameters used by the system to determine the current and/or future condition, e.g. responsive to editing or input equipment asset data or switching or selection of the at least one of the deterioration models and/or at least one of the barrier models.

The monitoring system may be, comprise or be comprised in or configured to communicate with a control system for an asset system. The monitoring system may comprise one or more processing modules, which may comprise one or more central processing units (CPUs), one or more graphical processing units (GPUs), one or more maths co-processors, one or more field programmable gate arrays (FPGAs), one or more application specific integrated circuits (ASICS), and/or the like. The system may be implemented by a server, server farm, cloud computing system, and/or other computing system. The monitoring system may comprise a computer system, which may be a network connected computer system.

According to a second example of the present disclosure is a computer implemented method for monitoring a system of physical assets, the method comprising:
collecting data relating to at least part of the system of assets;
implementing one or more deterioration models, each of the one of the one or more deterioration models being configured to model deterioration of at least one of the asset of the system of assets;
applying the data to the one or more deterioration models in order to determine a condition or degradation related parameter of the at least one asset; and
taking an action based on the determined condition or degradation related parameter of the at least one asset.

The method may comprise implementing set or pre-set barrier models, the barrier models modelling a resistance to the deterioration of the at least one asset. The set or pre-set barrier models could comprise one or more barrier models or may comprise no barrier model, e.g. for asset/deterioration mechanism combinations for which no barrier mechanism is present. The applying of the data may comprise applying of the data to the one or more deterioration models and to the set or pre-set barrier models, which may comprise zero or one or more barrier models, in order to determine a condition or degradation related parameter of the at least one asset.

According to a third example of the present disclosure is a computer program product configured to, when implemented on a processing system, causes the processing system to:
collect data relating to at least part of the system of assets;
implement one or more deterioration models, each of the one of the one or more deterioration models being configured to model deterioration of at least one of the asset of the system of assets;
apply the data to the one or more deterioration models in order to determine a condition or degradation related parameter of the at least one asset; and
take an action based on the determined condition or degradation related parameter of the at least one asset.

The computer program product may be configured to cause the processing system to implement set or pre-set barrier models, the barrier models modelling a resistance to the deterioration of the at least one asset. The set or pre-set barrier models could comprise one or more barrier models or may comprise no barrier model, e.g. for asset/deterioration mechanism combinations for which no barrier mechanism is present. The applying of the data may comprise applying of the data to the one or more deterioration models and to the set or pre-set barrier models, which may comprise zero or one or more barrier models, in order to determine a condition or degradation related parameter of the at least one asset.

According to a fourth is a device, such as but not limited to a mobile or network enabled device, comprising or configured to implement the system of the first example and/or the method of the second example and/or the computer program product of the third example. The device may be or comprise or be comprised in a mobile phone, smartphone, PDA, tablet computer, laptop computer, server, server farm, cloud computing system, control system for a system of assets, and/or the like. The method of the second example may be implemented by a suitable program or application (app) running on the device. The device may comprise at least one processor, such as a central processing unit (CPU), maths co-processor (MCP), graphics processing unit (GPU), tensor processing unit (TPU) and/or the like. The at least one processor may be a single core or multicore processor. The device may comprise memory and/or other data storage, which may be implemented on DRAM (dynamic random access memory), SSD (solid state drive), HDD (hard disk drive) or other suitable magnetic, optical and/or electronic memory device. The at least one processor and/or the memory and/or data storage may be arranged locally, e.g. provided in a single device or in multiple devices in in communication at a single location or may be distributed over several local and/or remote devices. The device may comprise a communications module, e.g. a wireless and/or wired communications module. The communications module may be configured to communicate over a cellular communications network, Wi-Fi, Bluetooth, ZigBee, near field communications (NFC), IR, satellite communications, other internet enabling networks and/or the like. The communications module may be configured to communicate via Ethernet or other wired network or connections, via a telecommunications network such as a POTS, PSTN, DSL, ADSL, optical carrier line, and/or ISDN link or network and/or the like, via the cloud and/or via the internet, or other suitable data carrying network. The communications module may be configured to communicate via optical communications such as optical wireless communications (OWC), optical free space communications or Li-Fi or via optical fibres and/or the like. The device and/or the controller or the at least one processor or processing unit may be configured to communicate with the remote server or data store via the communications module. The controller or processing unit may comprise or be implemented using the at least one processor, the memory and/or other data storage and/or the communications module of the device.

The invention includes one or more corresponding aspects, embodiments or features in isolation or in various combinations whether or not specifically stated (including claimed) in that combination or in isolation. As will be appreciated, features associated with particular recited embodiments relating to systems may be equally appropriate as features of embodiments relating specifically to methods of operation or use, and vice versa.

The individual features and/or combinations of features defined above in accordance with any aspect of the present invention or below in relation to any specific embodiment of the invention may be utilised, either separately and individually, alone or in combination with any other defined feature, in any other aspect or embodiment of the invention.

Furthermore, the present invention is intended to cover apparatus configured to perform any feature described herein in relation to a method and/or a method of using or producing, using or manufacturing any apparatus feature described herein.

The above summary is intended to be merely exemplary and non-limiting.

### BRIEF DESCRIPTION OF THE FIGURES

A description is now given, by way of example only, with reference to the accompanying drawings, in which:

FIG. 1 a block diagram of a monitoring system for monitoring a system of assets.

FIG. 2 a functional schematic operation of the monitoring system of FIG. 1.

FIG. 3 a flowchart of a method of monitoring a test point as part of the operation shown in FIG. 2.

FIG. 4 a schematic of an example of a deterioration model that can be used in the process of FIG. 2.

FIG. 5 a schematic of the data flow in the process of FIG. 1.

FIG. 6 a data output table as a visualisation action arising from the process of FIG. 2.

FIG. 7 a heat map as an example of a visualisation action arising from the process of FIG. 2.

FIG. 8 an annotated PID diagram as an example of a visualisation action arising from the process of FIG. 2.

### DESCRIPTION OF SPECIFIC EMBODIMENTS

Various specific examples are shown the drawings and described below. These are intended to give examples of possible implementations of the present disclosure but are not intended to be limiting.

Inspection and monitoring of physical assets is of critical importance in many industries. Systems of assets can be monitored in order to evaluate deterioration of the asset over time in order to assess time for maintenance or replacement of an asset or part of an asset before the asset is the subject of an adverse event. However, determining accurate deterioration of assets can be difficult, and subject to many variables. Furthermore, it is beneficial to include a wide range of data in an analysis, but increasing the range of data sources can lead to unreliable data and reduced confidence in the result, with associated impact on the effectiveness of the asset monitoring. Methodology described herein seeks to improve asset monitoring, by predicting failures; providing accurate corrosion or other deterioration rates & remaining life; improving the understanding of asset risks; better targeting inspection and allocation of resource; and/or optimise inspection coverage.

The methods described herein are generally applicable to a system of physical assets. A specific non-limiting example of a system of asset is a flow system comprising one or more assets such as pies or pipework, pumps, valves, meters, tanks, and/or the like. Such flow systems are commonly used in the oil and gas industry, both upstream and downstream, in chemical processing, in factories and other production or processing facilities, water treatment, energy generation and storage, food handling and processing, agricultural processes, and others from among a number of other possibilities. However, the present disclosure is not limited to these examples, and can in principle be applied to any suitable situation that comprises a system of assets where the assets are subject to some form of deterioration, and assessment of that deterioration in order to perform some form of action depending on the deterioration is required.

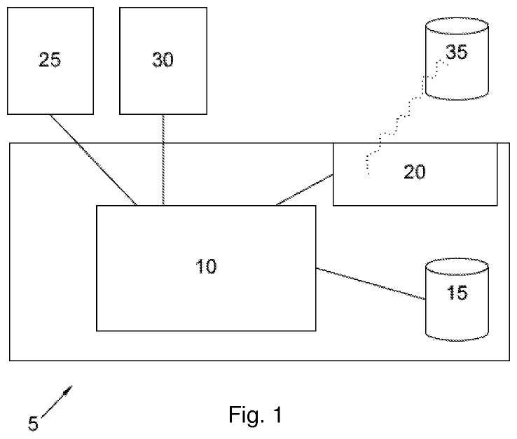

FIG. 1 shows a non-limiting example of a monitoring system 5. In some examples, the monitoring system 5 can be comprised in a controller of the system of assets, but need not be limited to this and could be, for example, a separate planned maintenance system, or other asset monitoring system.

The monitoring system 5 comprises at least one processor 10, a data store 15, a communications system 20, one or more output devices 25 and one or more user input devices 30. The communications system 20 comprises wired and/or wireless communications capability and is configured to communicate with one or more remote data stores 35. The at least one processor 10 comprises one or more processing units (e.g. CPUs, GPUs, maths co-processors, FPGAs, and/or ASICS) that are configured to retrieve data directly from the local datastores 15 and/or from the one or more remote datastores 35 via the communications system 20 and/or from one or more remote sensors, measurement systems or other data sources via the communications system 20 in order to retrieve data, such as inspection reports, and any other data or information required, such as information on the circuit or components thereof, such as pipe and other component material specifications, operational data, data and reports from current risk based inspections (RBIs), circuit details (e.g. P&ID or other circuit diagrams), lists of known anomalies, models and isometric representations of the circuit, corrosion models or other behaviour for the circuit or components thereof, and/or the like. The sensor data could include, for example, flow sensor data, temperature sensor data, expansion data, pressure data, gas sensor data, pH data, moisture level, and/or the like. The data accessible by the at least one processor 10 could also include process data, e.g. time stamped state or condition data showing the time spent in one or more operational state (which may include on and off state and/or other operations states, e.g. standby, degree of power, etc.), flow rates, valve positions, and/or the like. The data stores 15, 35 may comprise one or more hard disk drives, magnetic disks or other forms of magnetic storage, solid state memory devices such as flash drives, SSD drives, network attached storage (NAS), i-RAM, a RAM drive, optical disks or one or more other forms of optical storage, and/or the like. The at least one processor 10 is also configured to receive manual user input (e.g. user selections and/or data) from the one or more user input devices 30. The at least one processor 10 is configured to provide control commands and data to the one or more output devices 25, which may be local output devices physically or wirelessly connected to the processing system 10 and/or remote output devices that are connected to the processing system via the communications system 20. A particular example of an output device 25 is a visual output device such as a screen or monitor but is not limited to this.

The monitoring system 5 is configured to rapidly asses, cleanse, correct and present asset inspection data, sensor data, process data and/or other stored or real time data, and determine, predict or estimate degradation rates applicable to the assets of the system. To determine the degradation rates applicable to a given asset, the system has the functionality to apply competing models, namely a deterioration model for one or more or each deterioration mechanism applicable to the model, such as rusting, corrosion, abrasion, and/or the like, and optionally (if applicable) one or more barrier models that act to counter (e.g. to slow or otherwise mitigate) the deterioration. For example respective barrier models can model respective mitigation mechanisms such as modelling the effect of barrier mechanisms like protective layers or coatings, the effect of protective additives, beneficial heating, cooling or hydration regimes, and/or the like. The output of the deterioration models, modified by any barrier models if applicable, can be input into one or more predictive models. As such, the calculations of any applicable degradation rates and/or the predictions based thereon can be used to determine current, and predict future, properties or parameters of constituent assets based thereon, in a consistent and auditable manner, thereby enabling and providing evaluation of a threat level of failure or some other reportable action or alarm with respect to a machine state of the assets. This may improve both inspection and anomaly management by analysing, cleansing and improving the accuracy of inspection data already gathered, and by providing confidence values and/or supporting justifications in order to improve confidence in the data and allow better informed operating actions to be taken. This may also provide improved monitoring of a state or condition of the asset. However, in some cases no barrier mechanism may be present. As such, no barrier mechanism could be used for at least some assets. The competing degradation and barrier mechanisms applied for at least some of the assets.

The inspection data generally relates to the assets of the system of assets, e.g. a fluid circuit comprising various components such as valves, pumps, and the like, connected by pipework. One specific example of an asset is a sub-surface, sub-sea and/or surface based fluid circuit such as those used in oil and/or gas extraction and/or processing, but the present invention is not limited to this. The inspection reports may comprise one or more datasets collected by sensors or measurement tools configured to measure one or more properties or parameters of at least part of the asset or circuit, such as wall thickness sensors, temperature sensors, impedance sensors, magnetic field sensors, electric field sensors, electromagnetic sensors, acoustic sensors, time-of-flight sensors, flow meters, pressure sensors, speed sensors, and/or the like. The sensor or measurement tool data can be provided to the at least one processor 10 via the communications system 20 using any of the communications channels described above, which may be in real time or near real time, and/or may be stored in and provided by the local or remote data stores 15, 35. The inspection reports may comprise one or more dataset that comprise manually assessed and/or input data such as data collected and/or input by an inspection engineer. One or more of the datasets may comprise operational data from the operation of the asset or circuit, e.g. collected from an asset or circuit controller or other device that can provide operational data.

The datasets may include current, recent and/or historical data and may be received in a variety of different formats. So for example, at least one of the datasets accessed and used by the monitoring system 5 may comprise, for example, on or more of: recent and/or historic inspection reports, material classes and/or specifications for one or more components of the system or asset such as pipe classes, specifications, degradation models or rates, operational data for the asset or circuit, e.g. temperature, pressure, operating limits, e.g. maximum and/or minimum limits, such as maximum allowed wall thickness (MAWT), any alarm details, current risk based inspections (RBIs), details of the asset or circuit such as the P&ID or other circuit diagram, listing and details of any components of the circuit or asset, a list of known anomalies, isometric or other models of the asset or circuit, process flow diagrams (PFDs), and/or the like. The data could comprise sampling results and/or sensor results, from instrumentation and/or manual recording. Examples of parameters represented in the data include pressure, temperature, flow rate, flow volume, volume, level, weight, and/or the like.

Examples of the types of data that may be provided as advanced insights are described below. However, it will be appreciated that the advanced insights are not limited to this and other data, visualizations or alarms could be provided.

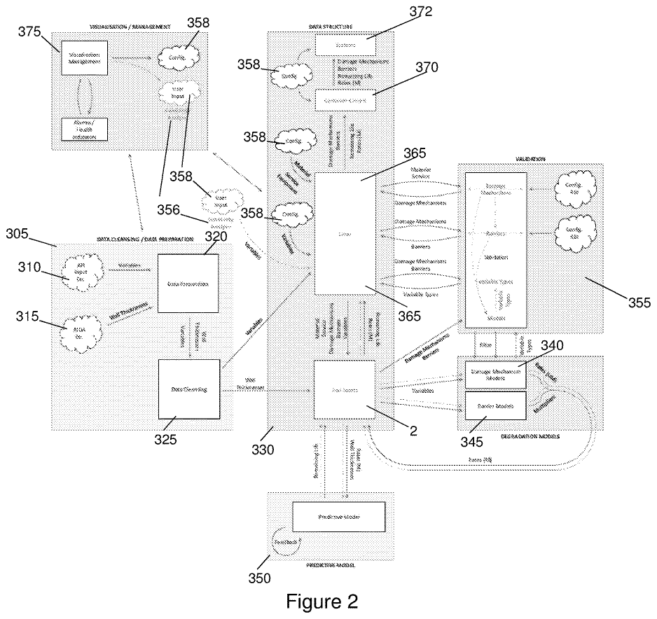

FIG. 2 shows an overview of the operation of the monitoring system 5 of FIG. 1 to monitor a system of assets.

Shown at 305 is a data receiving process.

Data from various data sources, is received or accessed by the monitoring system 5 and is used as the datasets input to the process. For example, data can be received by an API or other interface mechanism 310 collecting data, such as PI data, from a controller of the system of assets. Such data could include, for example, operating data relating to operation of the system of assets, sensor data or data from other measurement devices collected from the system of assets, and/or the like. Other examples of such data may include inspection data 315, which can include manual and/or automated inspection data, which has been previously collected and stored in a database from which it can be retrieved or transmitted directly to the monitoring system 5. The collected data can be comprised in datasets of related data such as data for one or more of: a common location in the system of assets or test point, a common time period, a common line or corrosion circuit, relate to assets exposed to a common environment or of a common type, relate to assets providing a common function or functional module, and/or the like. The collected data can comprise values of any parameters or variables relating to the system of assets, such as wall thickness of at least part of at least one or each asset of the system of assets.

The data receiving process 305 comprises a data preparation process 320. The data preparation process may include any file format conversion that might be required. In some examples, the data preparation process 320 comprises identifying and filling in gaps in the data, e.g. by interrogating different databases, providing a data request (e.g. by electronic message, displaying the request on a screen, including the request in an electronic report, etc.), extrapolating data, and/or the like.

The data sources run the gamut from sparse in time (<1 yr⁻¹) to very dense (>1 s⁻¹). The data sources are commonly sparse in space, with sensors or measurements only being located at a few points within a system. Both degrees of sparseness are managed through aggregation, and the manner of aggregation will depend both on the variable and the use to which it is being put. Types of aggregation of data that could be used include spatial aggregation and/or temporal aggregation. At this stage, some temporal aggregation of the data may be performed.

Where there is a gap in measurements, until a new measurement is made, the monitoring system 5 continues by using the latest measurement. When a new measurement becomes available, the gap is filled by linear interpolation between the two end points. All aggregation methods assume data cleansing to remove spikes and other clearly erroneous values, which is particularly beneficial when using PI data.

The data receiving process 305, in some examples, comprises re-formatting at least one of the datasets into a new format. The data receiving process 305, in some examples, comprises converting data from a format associated with one software package to another. The data receiving process 305, in some examples, comprises applying a map to map data from at least one of the datasets, e.g. in one format, into a standardized dataset in another format. The data receiving process 305, in some examples, determining properties of the data such as identifying potentially unreliable data, e.g. flat-lining, deviation from acceptable ranges and/or the like, with subsequent removal or correction of data deemed unreliable.

The data receiving process 305 comprises a data cleansing process 325 in which data deemed to be unreliable or erroneous can be removed or flagged for correction, checking or re-measurement.

The data receiving process 305 also comprises assigning confidence values to the data or to datasets. The confidence values may be determined in any suitable way, e.g. statistically or based on set or pre-set rules. For examples, data having a larger spread (e.g. intra-dataset variation) may be determined to have a lower confidence value. Highly variable data (e.g. data showing a higher degree of variation relative to other datasets or a long term trend, e.g. inter-dataset variation) may be given a lower confidence value. In another example, rules may be set or pre-set. For example a rule may specify one or more thresholds defining a likely or realistic limit on a value or band of values for a parameter or variable, wherein the value of any data falling above, below or outwith the threshold or band, as applicable, can be assigned a lower confidence value than otherwise similar data falling within the threshold or band.

Justification data indicating how or why the confidence value was arrived at can also be determined and appended to allow more nuanced use of the confidence data, e.g. as tie-breaker logic or to assist subsequent manual inspection of data having borderline or low confidence values.

The confidence values can be used in different ways, depending on the application. For example, the data could be weighted depending on confidence value. Additionally or alternatively, data could be removed or flagged for re-inspection or checking if the confidence value of the data is below a defined threshold or fails to meet a required rule. In other examples, the threshold or required rule for acceptable confidence value can be changed or adjusted dynamically, e.g. to achieve a required amount of data or to investigate the effect of changing the confidence value threshold or rule to determine the robustness of the process as a whole.

Once the data/datasets have been suitably collected, prepared 320 and cleansed 325, then these are processed as part of an hierarchical data structure 330. The data structure 330 in this example is arranged in a hierarchical structure, although in other examples this need not be the case. In this example, the hierarchical structure is arranged so that the assets are arranged by test point 2, by lines 365, by corrosion circuits 370 and at a system 372 level. At least one of the parameters, such as wall thickness, and/or variables represented in the data/data sets from the data receiving process 305 are input into a first level of the hierarchical data structure 330. As this level, some of the parameters and variables are associated with test points 2 but can generally be applied at other locations (e.g. to assets or parts of the system) to which those parameters or variable apply. For example, variables such as flow rate and temperature measured t specific locations in a pipeline, can be applicable over a certain distance downstream along the pipeline from the measurement points, and to any assets provided therein. The processing of the data at this level utilises one or more deterioration or damage models 340, wherein each of the one of the one or more deterioration models 340 are configured to model deterioration by a specific mechanism. Different mechanisms are applicable to different equipment assets. As such, the one or more deterioration models 340 for the specific deterioration mechanisms applicable to each asset are used to model deterioration of that particular asset or part of the system. The processing of the data also utilises one or more barrier models 345, wherein each of the one or more barrier models 345 model a different type of resistance to deterioration or barrier mechanism. Similarly to the deterioration models 340, different barrier mechanisms are applicable to different assets. As such, the one or more barrier models 345 that model the barrier mechanisms applicable to a given asset are applied to model or otherwise account for the resistance to degradation for that particular asset or part of the system. In this way, the one or more deterioration models 340 and the one or more barrier models 345 are employed as opposing processes in order to more accurately model overall degradation, which is a factor of both deterioration mechanisms and barrier mechanisms. Furthermore, deterioration models 340 and/or barrier models 345 specific to the deterioration mechanisms and/or barrier mechanisms appropriate for each given asset or part of the system can be selectively used for the respective asset or part of the system.

The one or more deterioration or damage models 340 have inputs including parameter and/or variable values from the data at the test point 2 level to provide properties of assets associated with each test point 2, such as corrosion rates (mmyr⁻¹), probabilities of failure (High/Med/Low), remaining lifetime, and/or the like, optionally along with an associated confidence value indicating a confidence in the accuracy of the output of the one or more deterioration model 340.

The one or more barrier models 345 either apply a multiplier to the outputs of the one or more deterioration models 340, or re-run the relevant deterioration models 340 with different (modified) input variable values, with the modification to the input variable values being to account for the effect of the barrier mechanism. For example, the one or more barrier models 345 can receive an unmitigated corrosion rate output by the one or more deterioration model 340 and output an updated (e.g. mitigated) corrosion rate based thereon. Optionally, the one or more barrier models 345 can also output a confidence value indicating a confidence in the accuracy of the output of the one or more barrier models 345. In addition, the one or more barrier models 345 can also output a status value indicating an effectiveness or current effectiveness of the barrier mechanism. In some examples, in addition to the confidence value, justification data indicating a justification for the confidence, e.g. how a confidence value was arrived at or the like, can also be included. The same could also apply for the degradation models 340, i.e. each degradation model 340 can also output a confidence value indicating a confidence in the accuracy of the output of the one or more degradation models 340. Optionally, in addition to the confidence value, justification data indicating a justification for the confidence, e.g. how a confidence value was arrived at or the like, can also be included.

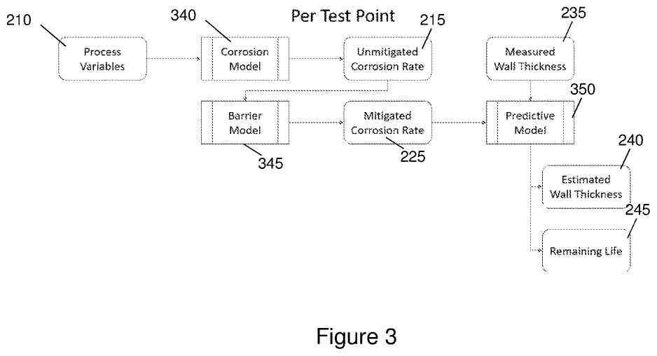

The application of the deterioration models 340 and barrier models 345 is shown in more detail in FIG. 3.

FIG. 3 illustrates a process of monitoring a test point 2 in a system of assets as part of the process described herein with respect to FIG. 2. For example, a test point 2 may be a point in the system of assets for which monitoring data is available, e.g. due to one or more sensors being located at, or providing data indicative of a condition at, the test point 2, or manual inspection data being available for, or being indicative of a condition at, the test point 2, and/or the like.

Data 210 for the test point 2 is received by the monitoring system 5. In this example, the data 210 comprises process variables required as inputs to the one or more deterioration models 340 and/or the one or more barrier models 345. Beneficially, data 210 may be automatically ingested by the monitoring system 5. For example, the monitoring system 5 may be in communication with sensors or other measurement devices that collect measurements at, or relating to, the test point 2. Additionally or alternatively, the monitoring system 5 may be configured to automatically query a controller of the system of assets (e.g. a provider of PI data) or databases or other data sources for new data or datasets and automatically ingest any new data found. Examples of such data 210 can include sensor measurements, inspection data, asset data, process data and/or the like.

The monitoring system 5 implements the one or more deterioration model 340 that models deterioration of at least one of the equipment assets associated with the test point 2. The data 210 may be time and date stamped, and optionally also provided with a location ID indicating a location in, or part of, the system of assets to which the data 210 relates. Importantly, some of the data 210 being collected at test points 2 having a specific location can be independent of the locations or assets to which that data is applicable. For example, even though some data 210 may be collected at a specific location, that data 210 may still be applicable to assets at other locations. For example, a temperature or flow measurement at a specific location in a pipe may still be applicable for a certain distance downstream along the pipe, and as such could be applicable to several devices along the pipe or to several locations along the pipe. As such, the applicability of the data 210 to an asset is not necessarily governed by co-incident location or solely by location, but can be indicated by a mapping, which can be set, pre-set or updated on the fly and can be a many to one, many to many or one to many mapping of data locations to assets. Beneficially, the data can also be associated with a confidence value, indicating a confidence that the data is accurate and optionally also a justification of the confidence value, such as an indication of how the confidence value was arrived at or why it meets or fails to meet one or more confidence conditions, or the like.

The one or more deterioration models 340 are selected to model the deterioration mechanisms applicable to the assets associated with that test point 2 according to the validation 355. For example, if the assets comprise carbon steel pipework in multiphase service, the deterioration mechanisms applicable to the pipework could include CO2 corrosion, erosion, and sulphide stress cracking. In this case, the one or more deterioration models 340 comprise a corrosion model, an oxidation model, an erosion model and a pitting model. As non-limiting examples, each deterioration model 340 can take as inputs parameters such as one or more of: a material of construction, an initial wall thickness, chemical composition of fluid to which the asset is exposed, time that it is exposed to the fluid, time that the asset is in operation, flow rate, temperature and any other parameters that has a significant bearing on the particular deterioration mechanism and/or others. Deterioration models 340 can be formed in a variety of ways and are to an extent dependent on the particular deterioration mechanism being modelled. However, in general, the deterioration model 340 takes relevant data as inputs and returns a value of a condition or degradation related parameter of the at least one asset such as deterioration, deterioration rate, remaining lifetime and/or the like.

In this example, an output of the one or more deterioration models 340 is an unmitigated deterioration rate 215, i.e. a rate at which the assets associated with the test point 2 would deteriorate in the absence of any mitigating mechanisms. However, in real life systems, there is often some form of mitigating mechanism, such as a protective barrier or coating, dehydration arrangements, deterioration preventing chemicals, such as corrosion inhibitors, biocides, antioxidants, free radical scavengers, and/or the like, are provided. In order to address this and more accurately model the degradation of the assets, one or more barrier models 345 are used.

The one or more barrier models 345 model resistance to deterioration of at least one of the assets associated with the test point 2. The barrier models 345 act in opposition to the deterioration models 340. In the example shown in FIG. 3, the one or more barrier models 345 receive the output of the one or more corrosion model 340 as an input, in this case including at least the unmitigated corrosion rate. The one or more barrier models 345 process these inputs, along with any other parameters from the data required by the one or more barrier models 345 in order to generate an output, which in this example includes at least a mitigated corrosion rate 225. The mitigated corrosion rate 225 is equal to the unmitigated corrosion rate 215 modified to account for the effect of each of the applicable barrier mechanisms as modelled by the one or more barrier models 345.

Beneficially, a barrier model 345 is provided to model for each barrier mechanism and a deterioration model 340 is provided for each deterioration mechanism. Also beneficially, the one or more barrier models 345 and the one or more deterioration models 340 can be provided as separate logical (or in some cases physical) modules or processes, wherein the rest of the process simply sends any required data and/or parameters as inputs to the relevant model and receives the output from the model. In these ways, it is easier to interchange and introduce new or updated deterioration and/or barrier models 340, 345. This makes it easier to keep the models 340, 345 current and updated. New deterioration and barrier models 340, 345 that can provide better modelling of deterioration or barrier processes can be added and/or deterioration and barrier models 340, 345 that model for new deterioration or barrier mechanisms can be more easily added.

The output 225 from the barrier model 345 is provided to a predictive model 350. The predictive model 350 also receives one or more relevant properties or parameters 235 extracted from the data, such as wall thickness, of the assets required to perform any calculations or predictions. The predictive model 350 then processes the one or more properties or parameters 235 and the output 225 from the at least one barrier model 345 in order to determine at least one condition or degradation related parameter 340, 345 of the assets associated with the test point 2. In this example, the one or more properties or parameters 235 input into the predictive model 350 includes wall thickness (e.g. at the start of operation or as measured) and the at least one condition or degradation related parameter 240, 245 output by the predictive model 350 includes an estimated current and/or predicted future wall thickness and/or a remaining life of the relevant asset. However, it will be appreciated that other properties of parameters 235 used as inputs and/or at least one current or predicted property or parameter 240, 245 could be used.

The use of at least one deterioration model 340 and optionally at least one barrier model 345 (if applicable) to determine a mitigated deterioration rate, remaining life and/or extent of deterioration allows for improved modelling of the deterioration and current state of the assets being modelled, and therefore allows for more accuracy in the actions being ultimately taken, such as raising alarms or flags or planning maintenance, repair or other intervention. The use of at least one deterioration model 340 and optionally at least one barrier model 345 as stand-alone modules or processes that are separate from the rest of the processes, that receive an input from, and send an output to the other processes, allows the at least one deterioration model 340 and optionally at least one barrier model 345 to be updated and new models installed faster and/or more easily.

As noted above, the one or more deterioration models 340 and/or the one or more barrier models 345, if used/applicable, exist independently from the rest of the system as functions, such that individual models 340, 345 are interchangeable and may be modified or replaced as required. In addition, different models 340, 345 can be used and easily interchanged for different users or assets.

Different models 340, 345 are appropriate for different situations, e.g. for different materials, different mechanisms, different assets, different chemical environments, for different outputs, and/or the like. As such, the appropriate models 340, 345 can be selected (e.g. pre-selected or dynamically selected) for particular test points 2 depending on the situation at that test point 2, e.g. for different materials, different mechanisms, different assets, different chemical environments, for different outputs, and/or the like.

Some non-limiting examples of deterioration models 340 and barrier models that could be used are provided for illustration, although it will be appreciated that one of the benefits of the present system is that it is very easy to substitute, select or interchange deterioration model 340 and/or barrier model 345, e.g. to provide improved or otherwise updated models, models appropriate for different or new situations, to model new or replacement assets, and/or the like.

An example of a deterioration model 340 is a CO₂ corrosion model, which models corrosion as a result of the presence of CO₂ in assets formed of materials that are adversely affected by carbon dioxide. This model outputs corrosion rate and an associated confidence value (and optionally also justification data providing justification for the confidence value). Examples of situations where it can be applied include multiphase systems, systems in which there is produced gas, produced oil or produced water, flare or closed drains, amongst others. Materials to which this degradation mechanism is applicable include carbon or low alloy steel. Examples of parameters and variables input to the model include temperature, pressure, gas (CO2) concentration, alkalinity, salinity, flow, viscosity, gas composition, water content, and others. The model is provided with an ID of the asset (e.g. pipe) to which it is being applied to allow the calculated corrosion rate to be linked with the specific asset (and thereby the specific level in the hierarchical arrangement, such as test point 2, line 365, and corrosion circuit 370). The model is also provided with applicable properties of the asset such as surface roughness, material composition such as steel type, and/or the like. Various CO₂ corrosion models provided for other applications are available in the literature or could be devised and can be straightforwardly re-purposed by a skilled person, so specific details are omitted, but the implementation of such models would be within the remit of the skilled person when prompted by the present teaching.

Other non-limiting examples of possible deterioration models 340 that could be used include models for at least one or more or each of: O₂ corrosion, erosion, preferential weld corrosion, seawater corrosion, organic acid corrosion, atmospheric corrosion, chloride stress corrosion cracking (CISCC), sulphide stress cracking, internal chloride pitting, microbiologically influenced corrosion, erosion-corrosion and flow-induced corrosion, external chloride stress corrosion cracking, external chloride pitting, and/or the like.

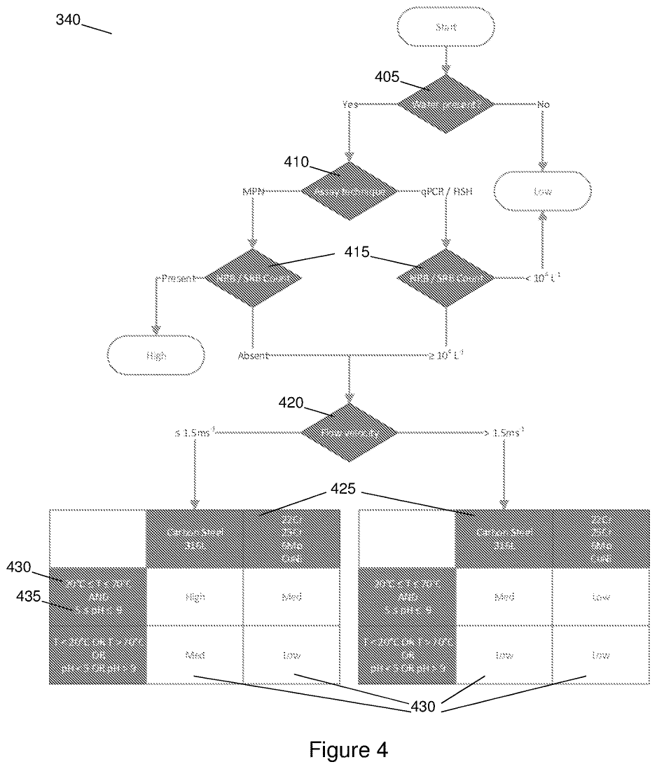

An example of a deterioration model 340 in the form of a microbiologically influenced corrosion model is shown in FIG. 4. In this case, the inputs of the deterioration model 350 include parameters and variables from the data including water presence 405, assay technique used 410, nitrate reducing bacteria (NRB)/sulphate reducing bacteria (SRB) count 415, flow velocity 420, material of construction 425 of the asset, temperature 430 and pH 435 in order to determine a probability of failure (PRB) 430, in this case in values of “low”, “medium” of “high”.

An example of a barrier model 345 is a lining model, such as a CRA lining model. This model works differently to the application of the barrier models described above. In this case, the barrier model 345 is implemented by providing a special material of construction in one or more of the deterioration models 340, with external properties of the asset (e.g. carbon steel of a pipe) and internal properties of the liner (e.g. a layer of the barrier material and a thickness of the liner wall). That is, this example of the barrier model is applied as a modification to the deterioration model 340 rather than being applied as a stand-alone barrier model 345, as is the case for other examples of barrier model 345 described herein.

As such, the barrier model 345 need not be applied in this way, and may be applied as a stand-alone model that receives the output (e.g. unmitigated corrosion rate 215 or other deterioration) of a deterioration model 340 as an input and acts on it to produce a mitigated corrosion rate 225 or other deterioration.

Further non-limiting examples of barrier models 345 include models for one or more of: a coating, dehydration, the presence of injected corrosion inhibitor, the presence of corrosion inhibitor in a closed loop, the presence of oxygen scavenger or deoxygenation agents, the presence of dihydrogen sulphide (H₂S) scavenger, the presence of a biocide, electrical isolation, and/or the like.

As noted above, a range of models that can be used or re-purposed as deterioration models 340 and/or barrier models 345 are available in the literature, e.g. in ISO, API, NORSOK, ASTM or other publications. The above models 340, 345 are provided as examples and other models could be used depending on the particular situation, e.g. depending on the deterioration mechanisms present, the materials used in the assets, the environment and/or materials to which the assets are exposed and/or the like.

The degradation models, i.e. the one or more deterioration models 340 and one or more barrier models 345 return output such as a mitigated deterioration rate 225 (e.g. a corrosion rate, a probability of failure and/or the like), or an unmitigated deterioration rate 215 and a multiplier or other modifier to account for the one or more barrier mechanisms. These are provided to the predictive model 350 to determine a condition or degradation related parameter for the test point 2. For example, the predictive model 350 can be configured to receive one or more mitigated deterioration rates or one or more unmitigated deterioration rates and barrier modifier from the one or more deterioration models 340 and one or more barrier models 345, along with a value for wall thickness, which could be a measured value or initial value. Based on these inputs, the predictive model 350 returns a condition or degradation related parameter such as remaining lifetime, chance of failure, predicted wall thickness or current level of deterioration at a present or future time, and/or the like.

Similarly to the one or more deterioration models 340 and one or more barrier models 345, the predictive model 350 is functionally separate from the rest of the process and operates as a stand-alone module or functionality in which inputs are sent to it (e.g. in the form of the mitigated or unmitigated deterioration rate(s) and/or the confidence values thereof, along with any required parameters or variables of the system of assets contained in the data) and the predictive model returns its output based thereon (e.g. the condition or degradation related parameter and/optionally confidence values therein). In this way, the predictive model is easier to upgrade or interchange.

Each model 340, 345, 350 is applicable to specific combinations of materials and environmental conditions. This is handled by the validation element 355 of the system in which the associated model 340, 345, 350 can be associated with particular metadata of an asset (typically test point 2) such as, but not limited to, service or material. The validation element 355 ensures that appropriate models are selected for different assets. However, the implementation of the models 340, 345, 350 is such that they will be able to return results even when the combination of service and material is invalid; as such the user may override the model selections made by the validation element 355. Where incorrect combinations of material and service are present, the model 340, 345, 350 will return “N/A” or similar. In this case, no result is provided, and the system should be able to identify that the model 340, 345, 350 is not applicable, and optionally raise a corresponding flag, alert and/or log entry.

It is likely that, in many cases, one or more of the variables required by a model 340, 345, 350 may not be available for certain test points 2. For each deterioration model 340 and/or barrier model 345, when there is required data that is missing, the model 340, 345, 350 can be configured to take a set or pre-set action such as, but not limited to, “Return Null”, which means that the model itself returns null, or to default to a set or pre-set default value, or to use an alternative value from an alternative source, to deploy an algorithm or relation to determine or estimate the value, and/or the like. Where certain variables are missing, a model 340, 345, 350 will return null. In this case, no result is provided, and the system should be able to identify the missing data, and optionally raise a corresponding flag, alert and/or log entry.

In some cases, a model 340, 345, 350 may not provide an output, for example where an iterative method fails to converge. In these cases, the model 340, 345, 350 shall return null, with the warning that the model 340, 345, 350 failed to provide an output.

By providing the validation facility 355, upgrade, interchange and addition of new models 340, 345, 350 is made easier, making the system easier to update and the system can be made more robust.

User input of control parameters such as thresholds, bands, or the like, or indeed any other configuration data 358 (e.g. control data) for controlling or configuring the process and the way it operations can be provided via other user input 360.

For example, a user interface can be provided allowing user input 360 and display of data, and the user interface may be configured to receive the user input 360. In examples, the user interface can be provided via a browser such as a web browser or other graphical user interface. This might include, in some examples, mechanisms to allow the user to temporarily edit values of one or more control parameters, thresholds, bands or the like, wherein the values of any such edited values are automatically propagated throughout the models and/or other processes shown in FIG. 2, as applicable, and perform any associated recalculations or updates so that the user can quickly see the effect of any changes as a sensitivity 356 mechanism. This real time or near real time ability to see the effect of any changes in control parameter can allow the user to quickly or more easily adjust operation of the system, e.g. to better reduce deterioration of one or more of the assets. Beneficially, because the user interface can provide the visualisations, and allows the above sensitivity control via the propagation of user set control parameters, the user can see the effect of changing the control parameters at a variety of hierarchical levels in the system of assets.

As noted above, the system of assets is modelled hierarchically, so that data can be extracted for smaller or larger parts of the system of assets. Each test point 2 relates to a location in the system of assets for which data is available, and could comprise, for example, an inspection site or measurement location in or on an asset such as a pipe. One or more test points 2 may be comprised in or are otherwise associated with a line 365 (or other part of the system of assets). In turn, one or more lines 365 may be comprised in a corrosion circuit 360 (or other, larger part of the system of assets).

The deterioration model 240, barrier model 350 and/or predictive model 350 can be applied for any level in the hierarchical data structure. The output of the predictive model 350 (e.g. the condition or degradation related parameter and/optionally confidence values therein) based on the output of the one or more deterioration models 340 and the one or more barrier models 345 (and optionally any of the data such as values of one or more parameters or variables) can be propagated up the hierarchical model to give values for other parts of the system of assets that are higher in the hierarchy. That is, the data and any values determined therefrom can be aggregated and propagated up through the hierarchy so that data indicating a state of that part of the system of assets for any given level of the hierarchy can be obtained and used for further actions, such as alarms, alerts, flags, log entries or for providing on a visualisation.

However, in some cases multiple sets of data or parameters from the data cleansing 325 are directly applicable to individual elements in the hierarchical structure, such as the test points 2 or lines 365, in which case, spatial aggregation of the data or parameters may be carried out. Examples of spatial aggregation that could be used include one or more or each of: summation (e.g. data from all relevant sensors is summed to provide the value used), average (e.g. the mean of the data from all relevant sensors is used), maximum (e.g. the maximum of the data form all relevant sensors is used), minimum (e.g. the minimum of the data from all relevant sensors is used), undefined (e.g. to be determined on a case by case basis), and/or the like.

The way data is aggregated may be specific to the specific mechanisms and models used (e.g. specific to the particular deterioration mechanism/model and/or to the particular barrier mechanism/model). This is also the case when multiple variables, parameters or data of the same type are available for a particular asset or part of the system for the same time range. In these cases, the mechanism by which the variables, parameters or data are aggregated or used is dependent on the specific deterioration mechanism/model and/or to the particular barrier mechanism/model and the particular variable, parameter or data. For example, a corrosion model may use the highest temperature (as this gives the “worst case” corrosion), or a cracking model may use a lowest temperature, or multiple values of a particular measurement such as flow rate may be averaged, or the like.

A visualisation system 375 is provided to allow the user to access the system. The output of the predictive model 350 (e.g. the quality, degradation or lifetime metric and/optionally confidence values therein and optionally also associated justification data), the mitigated or unmitigated deterioration rates determined using the one or more deterioration models 340 and the one or more barrier models 345, and optionally any of the data such as values of one or more parameters or variables relating to any level of the hierarchy of the system of assets from individual test points 2, through the lines 365 (or other parts of the systems of assets), corrosion circuits 370 up to the system of assets as a whole, can be provided using the visualisation system, along with any alerts, flags or alarms based thereon. For example, any of the output of the predictive model 350 (e.g. the condition or degradation related parameter and/optionally confidence values therein and optionally also associated justification data), the mitigated or unmitigated deterioration rates determined using the one or more deterioration models 340 and the one or more barrier models 345, and optionally any of the data such as values of one or more parameters or variables may be provided with associated alarm criteria, such as one or more thresholds, bands or other conditions, wherein if the alarm criteria are met then an alarm, alert of flag is raised and optionally provided using the visualisation system.

Temporal aggregation of the data could be performed. Examples of temporal aggregation that could be used include one or more or each of: none (e.g. multiple measurements within a time period such as on the same day will not occur), maximum (e.g. maximum of measurements within a given time period such as a given day is used), average (e.g. the mean of measurements within a given time period such as a given day is used), minimum (e.g. the minimum of measurements within a given time period such as a given day is used), undefined (e.g. determined on a case by case basis), and/or the like. A time frame for which temporal aggregation is to be performed can be selected or specified by a user, and the system may be configured to aggregate the data accordingly and output the temporal aggregation of the parameters or data on the visualisation.

Visualisation of the system can be provided for specified times or for specified time ranges, which could be specified by a user. The data specified may be a “roll-back” of data to a previous time or may involve a predicted state at a time or time range in the future, which may be achieved through use of the predictive model 350.

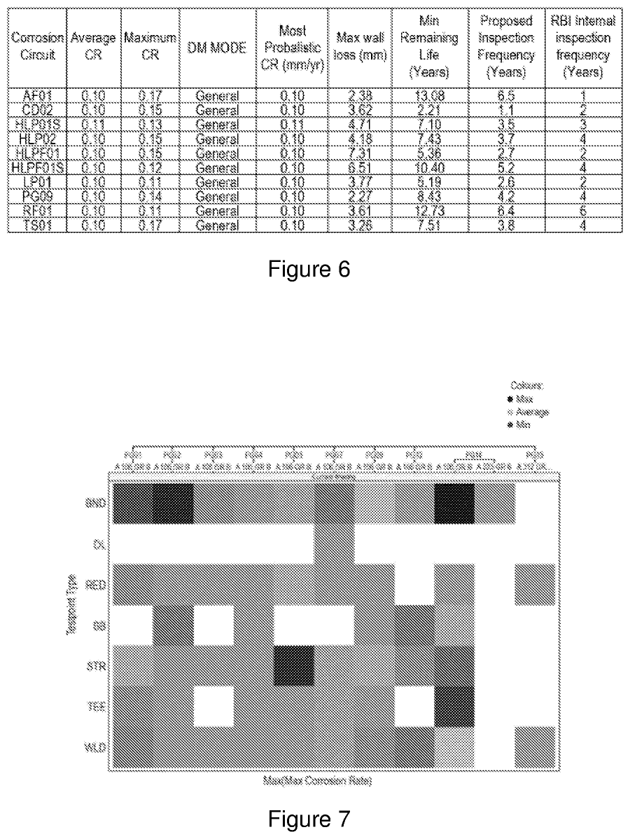

The visualisations provided by the visualisation system 375 can take any suitable form. For example, as shown in FIG. 6, the visualisation could take the form of a log or table for any level in the hierarchy of the system of assets, in this instance showing determined values such as maximum wall thickness loss, minimum remaining life, proposed inspection frequency and internal inspection frequency for each of a plurality of identified corrosion circuits 370 of the system of assets.

The visualisation system 375 is also configured to export any data or visualisations, e.g. to database, external servers or remote devices (including user devices such as mobile phones, tablets, etc.), or to output the log or any other visualisations in printed format.

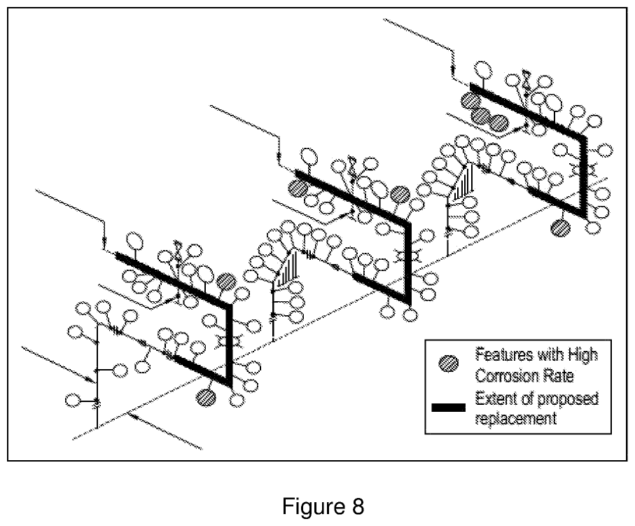

FIG. 7 shows a visualisation in the form of a heat map based on max corrosion rate and test point type. FIG. 8 shows a schematic diagram of the system of assets, in this example in the form of a P&ID diagram, which has been annotated to highlight areas of high corrosion rate (above a threshold).

In the above cases, the visualisations are underpinned by data including the output of the predictive model 350 (e.g. the condition or degradation related parameter and/optionally confidence values therein) based on the output of the one or more deterioration models 340 and the one or more barrier models 345; the mitigated or unmitigated deterioration rates determined using the one or more deterioration models 340 and the one or more barrier models 345; and optionally any of the data such as values of one or more parameters or variables.

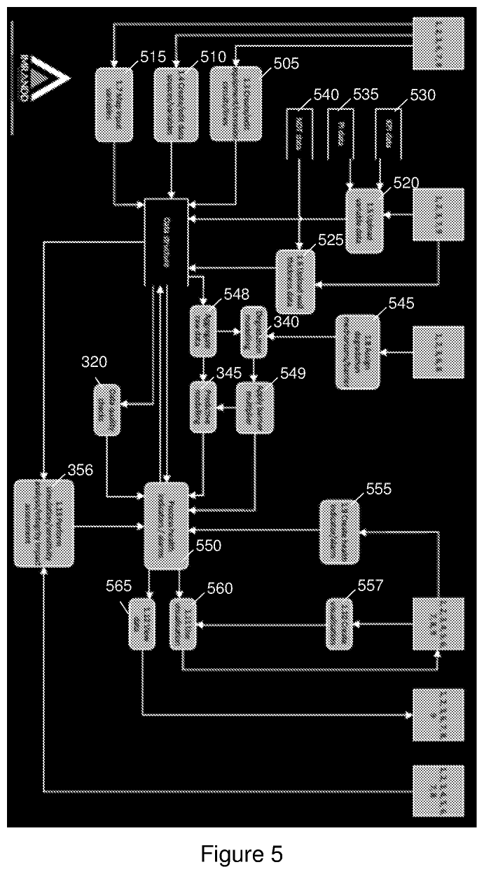

FIG. 5 is a schematic showing operators who can contribute to the system described above. The arrangement shown includes potential contributions from asset management service operators and operators of the system of assets itself. Data structure, e.g. the hierarchical data structure contains various data contributions.

Any of: asset management service administrators and engineers as well as user administrators, integrity managers, integrity engineers and corrosion engineers can create and edit assets, corrosion circuits, lines and other sections of the system of assets in the data structure in 505. In 510, any of: asset management service administrators and engineers as well as user administrators, integrity managers, integrity engineers and corrosion engineers can create and edit the set-up of variables and parameters in the data structure. In 515, any of: the asset management service administrators and engineers as well as user administrators, integrity managers, integrity engineers and corrosion engineers can set up maps of input variables to assets in various hierarchical levels of the system of assets. In 520 and 525, any of: asset management service administrators and engineers as well as user administrators, integrity engineers and inspection engineers can provide variables (variable data) and/or wall thickness data, e.g. from key performance indicator (KPI) data 530, process controller data (PI data) 535 and non-destructive testing data (NDT data) 540, which in turn is used to populate the data in the data structure.

Any of: asset management service administrators and engineers as well as user administrators, integrity managers, and corrosion engineers can assign 545 the deterioration and/or barrier mechanisms to use, which in turn governs at least in part the selection of the deterioration and/or barrier models 340, 345.

As described above in relation to FIG. 2, the data provided to the data structure is aggregated 548, and provided to the at least one deterioration model 340 and the predictive model 350 as inputs. The output from the at least one deterioration model 340 is optionally also provided to the at least one barrier model 345 (if applicable), which can apply a barrier modifier 549 or generate mitigated deterioration rates or lifetimes from the unmitigated deterioration rates output from the one or more deterioration models 340. These are also provided to the predictive model 350 as inputs. However, the provision of barrier models 345 is not essential, as a particular asset/degradation mechanism may have no barrier to that degradation or the type of degradation may be better modelled by modifying the degradation mechanism. However, generally the degradation/barrier opposing models provide improved results.

The output from the predictive model is provided to a health indicator and alarm module 550. The data provided to the data structure is checked and also provided to the health indicator and alarm module 550.

Any of: asset management service administrators and engineers as well as user administrators, asset managers, operations managers, integrity managers, integrity engineers, corrosion engineers and inspection engineers can create alerts, alarm and/or flag criteria 555 that are used to generate alarms, flags or alerts and can also create and customise the visualisations 557, all of which can be provided by the health indicator and alarm module 550 for provision to users. The visualisations can be viewed 560 by any of: asset management service administrators and engineers as well as user administrators, asset managers, operations managers, integrity managers, integrity engineers, corrosion engineers and inspection engineers. The data can be viewed 565 by any of: asset management service administrators and engineers as well as user administrators, integrity managers, integrity engineers, corrosion engineers and inspection engineers. Any of: asset management service administrators and engineers as well as user administrators, asset managers, operations managers, integrity managers, integrity engineers, and corrosion engineers can operate the validation facility 355 and provide sensitivity 356 and configuration data 358 as described above.

For ease of explanation, the above examples have been described as if used in relation to an asset that comprises oil and gas related pipelines, such as in a well structure extending below the surface, or the like. However, systems and methods described herein may be equally used and applicable in respect of other flow lines, not just those associated with oil and gas production, or indeed injection wells, etc. As such, while the following examples may be described in relation to oil and gas wells, and in particular production and appraisal wells, the same systems and methods, etc., may be used beyond oil and gas applications. A skilled artificer will be able to implement those various alternative embodiments accordingly.

Method steps of the invention can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customised circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a screen, e.g., a CRT (cathode ray tube), plasma, LED (light emitting diode) or LCD (liquid crystal display) monitor, for displaying information to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

1. A computer based asset monitoring system for monitoring a system of physical assets, the monitoring system being configured to:
collect data relating to at least part of the system of assets;
implement one or more deterioration models, each of the one of the one or more deterioration models being configured to model deterioration of at least one asset of the system of assets;
apply the data to the one or more deterioration models and the one or more barrier models in order to determine a condition or degradation related parameter of the at least one asset; and
take an action based on the determined condition or degradation related parameter of the at least one asset.

2. The computer based asset monitoring system of claim 1, configured to implement at least one set or pre-set barrier model, the barrier model modelling a resistance to the deterioration of the at least one asset; and apply the data to the one or more deterioration models and the one or more barrier models in order to determine a condition or degradation related parameter of the at least one asset.

3. The computer based asset monitoring system of claim 1, wherein the one or more deterioration models are configured to determine a deterioration rate and/or probability of the deterioration rate of the at least one asset.

4. The computer based asset monitoring system of claim 1, wherein at least some of the deterioration models model different degradation mechanisms.

5. The computer based asset monitoring system of claim 1, wherein the one or more deterioration models are configured to output the unmitigated deterioration rate and/or probability of the deterioration rate of the at least one asset.

6. The computer based asset monitoring system of claim 5, wherein the unmitigated deterioration rate and/or probability of the deterioration rate of the at least one asset output by the one or more deterioration models is provided as an input to the at least one barrier model.

7. The computer based asset monitoring system according to claim 6, wherein the at least one barrier model is configured to output a mitigated deterioration rate and/or probability of the deterioration rate.

8. The computer based asset monitoring system according to claim 1, wherein the data comprises at least one or more of:
real time data or near real time data relating to the at least one asset;
manually collected and/or provided data relating to the at least one asset;
historical data relating to the at least one asset;
sensor data relating to the at least one asset;
inspection data relating to the at least one asset;
operational data relating to operation of the at least one asset and/or the system of assets;
physical data of the at least one asset;
chemical data of chemicals to which the equipment asset has been exposed; and/or
initial physical properties of the asset.

9. The computer based asset monitoring system of claim 1, wherein at least one of:
the data is tied to a date and/or time of collection;
the data is tied to a location in the system of assets;
the data is not tied or otherwise associated with a specific location; and/or
the data is mapped to assets in a many to many or one to many arrangement.

10. The computer based asset monitoring system of claim 1 further comprising a predictive model, wherein the predictive model is arranged to receive at least one of: the output of the at least one barrier model and/or the output of the at least one deterioration model, and arranged to determine the condition or degradation related parameter of the at least one asset based thereon.

11. The computer based asset monitoring system of claim 1, wherein at least one of:
the data;
the output of the one or more deterioration models;
the output of the one or more barrier models: and/or
the output of the predictive model, is associated with a confidence value indicating a confidence that the data or output is accurate.

12. The computer based asset monitoring system of claim 1, configured to exclude, ignore or flag for checking or recollecting the data or output depending on its confidence value.

13. The computer based asset monitoring system of claim 1, configured to group assets in a hierarchical structure, and to aggregate and/or propagate data and/or determined conditions or degradation related parameters between assets or groups of assets in different levels of the hierarchical structure.

14. The computer based asset monitoring system according to claim 1, wherein the action comprises at least one of:
providing a visualization of the determined condition or degradation related parameter; and/or
raising an alarm, alert or flag.

15. The computer based monitoring system of claim 1, wherein the action is taken responsive to the determined condition or degradation related parameter of the at least one equipment asset meeting an action condition.

16. A computer implemented method for monitoring a system of physical assets, the method comprising:
collecting data relating to at least part of the system of assets;
implementing one or more deterioration models, each of the one of the one or more deterioration models being configured to model deterioration of at least one of the asset of the system of assets;
implementing set or pre-set barrier models, the barrier model modelling resistance to deterioration of the at least one asset of the system of assets;
applying the data to the one or more deterioration models and the set or pre-set barrier models in order to determine a condition or degradation related parameter of the at least one asset; and
taking an action based on the determined condition or degradation related parameter of the at least one asset.

17. A computer program product embodied on a non-transient computer readable medium and configured to, when implemented on a processing system, cause the processing system to:
collect data relating to at least part of the system of assets;
implement one or more deterioration models, each of the one of the one or more deterioration models being configured to model deterioration of at least one of the asset of the system of assets;
implement set or pre-set barrier models, the barrier model modelling resistance to deterioration of the at least one asset of the system of assets;
apply the data to the one or more deterioration models and the set or pre-set barrier models in order to determine a condition or degradation related parameter of the at least one asset; and
take an action based on the determined condition or degradation related parameter of the at least one asset.
